(19) United States
(12) Patent Application Publication
(10) Pub. No.: US 2012/0022888 A1
(43) Pub. Date: Jan. 26, 2012

(54) WEB-BASED TOOL FOR PATIENTS AND HEALTH CARE PROVIDERS TO NEGOTIATE SETTLEMENT OF PATIENT ACCOUNTS

(76) Inventor: David McKim, Kansas City, MO (US)

(21) Appl. No.: 13/189,384

(22) Filed: Jul. 22, 2011

Related U.S. Application Data
(60) Provisional application No. 61/366,886, filed on Jul. 22, 2010.

(51) Int. Cl. G06Q 50/00; G06Q 10/00

(52) U.S. Cl. 705/2

(57) ABSTRACT

A web-based tool for patients and health care providers to negotiate settlement of patient accounts includes a first website interface to receive a patient information from the patient, the patient information including a bill amount from the provider; a first module that utilizes a publicly available provider information to provide a cost/charge ratio for the provider; a second module that utilizes the cost/charge ratio and the patient information to produce a suggested bid; a third module to electronically provide the suggested bid to the patient; a second website interface to receive a patient bid from the patient; and a fourth module to electronically provide the patient bid to the provider. The patient information may further include a provider identification for the provider and an amount owed by the patient to the provider, and the provider information includes a publicly available Medicare Cost Report for the provider.

### RELATED APPLICATIONS

This application claims the benefit of the filing date of U.S. patent application No. 61/366,886, filed Jul. 22, 2010, which is incorporated herein by reference in its entirety.

### BACKGROUND OF THE INVENTION

The present invention generally relates to a web-based tool for patients and health care providers to negotiate settlement of patient accounts.

The current systems for collecting patient account balances do not provide for neutral, businesslike communication or negotiation between the patient and the health care provider.

Providers that utilize Medicare, such as hospitals, must file a yearly Medicare Cost Report which is publicly available. Other providers may utilize other insurance or social insurance programs that have cost reports or other strategic information that is publicly available.

It would be desirable to have a means for a patient to negotiate with health care providers for a discounted settlement-in-full of their account utilizing strategic information that is readily available to the patient.

### SUMMARY OF THE INVENTION

In one aspect of the present invention, a method for negotiating between a patient and a provider includes utilizing a website to receive a patient information from the patient, the patient information including a bill amount from the provider; utilizing a publicly available provider information to provide a cost/charge ratio for the provider; utilizing the cost/charge ratio and the patient information to produce a suggested bid; providing the suggested bid to the patient; utilizing the website to receive a patient bid from the patient; and providing the patient bid to the provider.

In another aspect of the present invention, a method for negotiating between a patient and a provider includes utilizing a website to receive a patient information from the patient, the patient information including a provider identification for the provider, a bill amount from the provider, and an amount owed by the patient to the provider; utilizing a publicly available provider information to provide a cost/charge ratio for the provider, the provider information including the provider's total charges, total costs, and net profit for the most recent year reported; utilizing the cost/charge ratio and the patient information to produce a suggested bid; providing the suggested bid to the patient; utilizing the website to receive a patient bid from the patient; and providing the patient bid to the provider.

In yet another aspect of the present invention, a computer system for negotiating between a patient and a provider includes a first website interface to receive a patient information from the patient, the patient information including a bill amount from the provider; a first module that utilizes a publicly available provider information to provide a cost/charge ratio for the provider; a second module that utilizes the cost/charge ratio and the patient information to produce a suggested bid; a third module to electronically provide the suggested bid to the patient; a second website interface to receive a patient bid from the patient; and a fourth module to electronically provide the patient bid to the provider.

### BRIEF DESCRIPTION OF THE DRAWINGS

FIG. 1 is a flowchart depicting an embodiment of the present invention; and

FIG. 2 depicts a further flowchart according to the embodiment of FIG. 1.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Broadly, an embodiment of the present invention generally provides a web-based tool for patients and health care providers to negotiate settlement of patient accounts.

An embodiment of the present invention may provide patients a tool to communicate with health care providers to ask for a discounted settlement-in-full of their account with use of more strategic information than is currently readily available to them. Embodiments may also give the health care provider the ability to respond to those requests efficiently and quickly.

An embodiment of a process may use provider information submitted to the federal government under legal requirement. The process may use a computer running a proprietary algorithm to analyze the provider's cost/charge ratio against the original bill amount. The algorithm may involve extraction and storage of the following data elements from the provider's Medicare Cost Report, or from another insurance program's cost report: total charges, total costs, and net profit for the most recent year reported. It then derives mathematically a cost-to-charge ratio. The cost-to-charge ratio may be, for example, a weighted sum that combines numerical values for these data elements. This ratio may be applied to the total bill or debt amount reported by the patient to estimate the provider's cost in that particular case. This application may be, for example, a multiplication of the cost-to-charge ratio with the provider bill.

The results of this analysis may be translated into an opening bid recommendation that is likely to be acceptable to the provider. The consumer may then be asked to make an opening bid. This may be transmitted to the provider. The provider may be asked to accept the bid or make a counter-offer. A counter-offer may be transmitted to the customer. The customer may then be asked to accept the provider's counter-offer or make a final settlement offer. In the absence of an agreement, the customer's final offer may be transmitted to the provider. The provider then may have an opportunity to make a “best and final” settlement offer. If no agreement is reached, the matter may be closed. If agreement is reached, the process may expedite payment to the provider.

An embodiment of a negotiation system may use the communication capabilities of the Internet along with the automated analytical capabilities of computers.

To use an embodiment, a customer with a medical bill may come to the website. The customer may use the website's capabilities to analyze their specific medical bill to determine if there is an opportunity to negotiate for a discount. A recommended initial offer may be made by the website algorithm. If the customer decides to proceed, the website may engage to communicate with the provider for the customer in an effort to negotiate a settlement of the bill or debt.

An embodiment of a website may be used to negotiate settlement of any type of bill or debt. Embodiments may provide a patient with strategic negotiating information and enable communication with a provider in a neutral, non-emotionally-charged, non-confrontational manner.

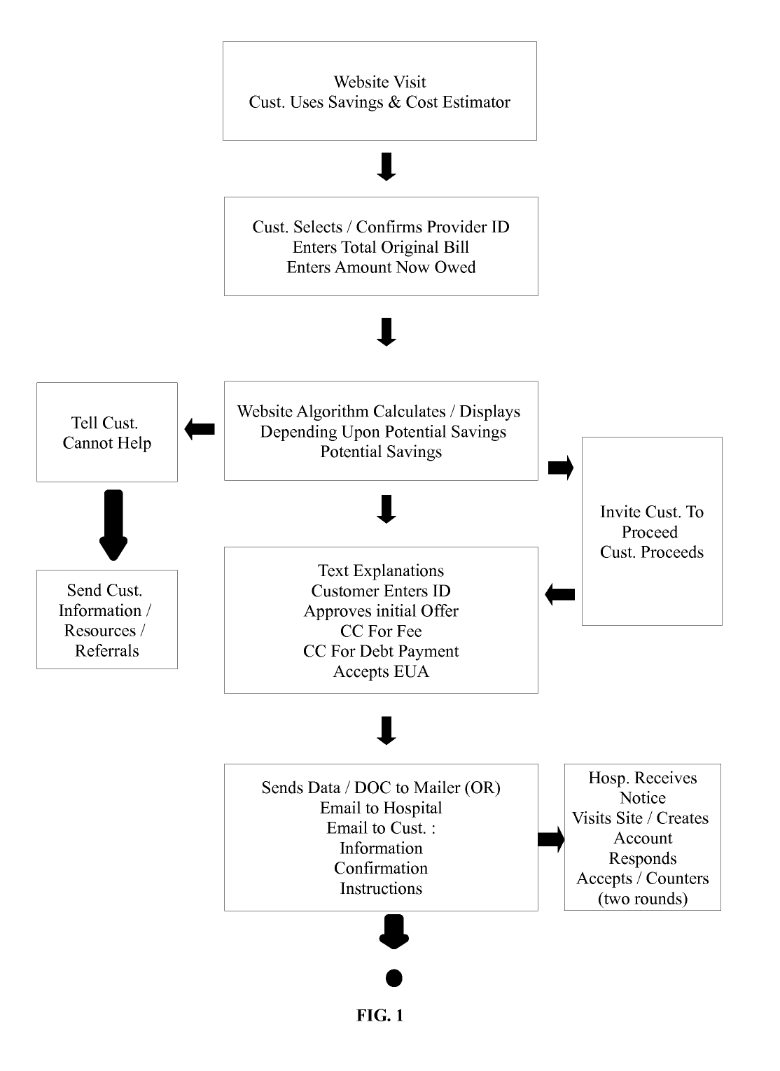

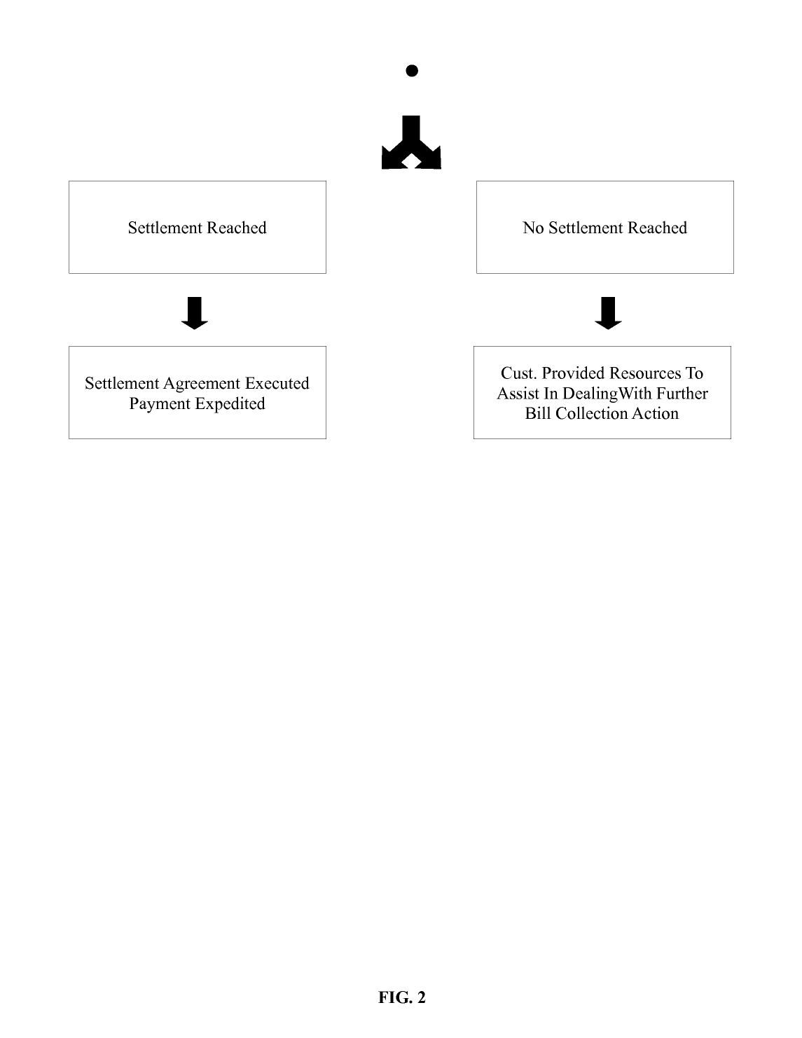

As depicted in the embodiments of FIGS. 1 and 2, a web-based tool for patients and health care providers to negotiate settlement of patient accounts may perform or support the following functions. An embodiment of a computer system may have several website interfaces, which may collectively be a single website, and may have several modules that run on a computer, which may be part of a computer program or a set of subroutines.

As depicted in FIG. 1, the customer visits a website, where the customer utilizes a savings-and-price-estimator module to estimate possible savings and a price. The customer selects and confirms a provider identification (Provider ID), enters a total original bill, and enters an amount now owing. The system calculates and displays potential savings. Depending upon the potential savings, the tool may tell the customer that the tool cannot help the customer, and send the customer information, resources, and/or referrals. Depending upon the potential savings, the tool may invite the customer to proceed, and the customer may proceed. The system may provide text explanations. The customer may enter a customer identification (Customer ID) and approve the initial offer. The customer may provide a credit card (CC) to pay the fee, the tool may utilize the CC for debt payment, and the system may accept an end user agreement (EUA). The tool sends documents via email to each party. The tool sends emails to the provider and customer that include the information provided by the customer, a confirmation, and instructions. The customer may re-visit the site, respond to inquiries, and participate in acceptance and counters, for at least two rounds. The provider receives notice, and provider personnel may visit a web site, create accounts, respond, and accept or counter the customer, for at least two rounds.

As continued in FIG. 2, if a settlement is reached, a settlement agreement is executed and the payment is expedited. If no settlement is reached, the customer may be provided resources to assist in dealing with further bill collection action.

Embodiments may include a method for negotiating with a provider, comprising: receiving a bill amount utilizing a website; utilizing a computer to analyze a cost/charge ratio for the provider against the bill amount and provide a suggested bid; receiving a bid utilizing the website; transmitting the bid to the provider; and asking the provider to accept the bid or make a counter-offer.

I claim:

1. A method for negotiating between a patient and a provider, comprising:
utilizing a website to receive a patient information from the patient, the patient information including a bill amount from the provider;
utilizing a publicly available provider information to provide a cost/charge ratio for the provider;
utilizing the cost/charge ratio and the patient information to produce a suggested bid;
providing the suggested bid to the patient;
utilizing the website to receive a patient bid from the patient; and
providing the patient bid to the provider.

2. The method of claim 1, wherein the patient information further includes a provider identification for the provider and an amount owed by the patient to the provider.

3. The method of claim 1, wherein the provider information includes the provider's total charges, total costs, and net profit for the most recent year reported.

4. The method of claim 1, wherein the provider information includes a publicly available Medicare Cost Report for the provider.

5. The method of claim 1, further comprising:
utilizing the website to receive an acceptance or a counter-offer from the provider.

6. The method of claim 1, further comprising:
utilizing the website to receive an acceptance from the provider, execute a settlement, and expedite payment.

7. The method of claim 1, further comprising:
utilizing the website to receive a first counter-offer from the provider;
providing the first counter-offer to the patient; and
utilizing the website to receive an acceptance or second counter-offer from the patient.

8. A method for negotiating between a patient and a provider, comprising:
utilizing a website to receive a patient information from the patient, the patient information including a provider identification for the provider, a bill amount from the provider, and an amount owed by the patient to the provider;
utilizing a publicly available provider information to provide a cost/charge ratio for the provider, the provider information including the provider's total charges, total costs, and net profit for the most recent year reported;
utilizing the cost/charge ratio and the patient information to produce a suggested bid;
providing the suggested bid to the patient;
utilizing the website to receive a patient bid from the patient; and
providing the patient bid to the provider.

9. The method of claim 8, wherein the provider information includes a publicly available Medicare Cost Report for the provider.

10. The method of claim 8, further comprising:
utilizing the website to ask the provider to accept the bid or make a counter-offer;
if the provider accepts the bid, executing a settlement and expediting payment; and
if the provider makes a counter-offer, providing the counter-offer to the patient and utilizing the website to receive an acceptance or second counter-offer from the patient.

11. A computer system for negotiating between a patient and a provider, comprising:
a first website interface to receive a patient information from the patient, the patient information including a bill amount from the provider;
a first module that utilizes a publicly available provider information to provide a cost/charge ratio for the provider;
a second module that utilizes the cost/charge ratio and the patient information to produce a suggested bid;
a third module to electronically provide the suggested bid to the patient;
a second website interface to receive a patient bid from the patient; and
a fourth module to electronically provide the patient bid to the provider.

12. The system of claim 11, wherein the patient information further includes a provider identification for the provider and an amount owed by the patient to the provider.

13. The system of claim 11, wherein the provider information includes the provider's total charges, total costs, and net profit for the most recent year reported.

14. The system of claim 11, wherein the provider information includes a publicly available Medicare Cost Report for the provider.

15. The system of claim 11, further comprising:
a third website interface to receive an acceptance or a counter-offer from the provider.

16. The system of claim 11, further comprising:
a third website interface to receive an acceptance from the provider, execute a settlement, and expedite payment.

17. The system of claim 11, further comprising:
a third website interface to receive a first counter-offer from the provider;
a fifth module to electronically provide the first counter-offer to the patient; and
a fourth website interface to receive an acceptance or second counter-offer from the patient.]
